(19) United States
(12) Patent Application Publication
(10) Pub. No.: US 2001/0023416 A1
(43) Pub. Date: Sep. 20, 2001

(54) Internet broadcast billing system

(76) Inventor: Masahiro Hosokawa, Tokyo (JP)

Correspondence Address: SUGHRUE, MION, ZINN, MACPEAK & SEAS, 2100 Pennsylvania Avenue, N.W., Washington, DC, 20037-3202, US

(21) Appl. No.: 09/805,117

(22) Filed: Mar. 14, 2001

(30) Foreign Application Priority Data
Mar. 15, 2000 (JP) P2000-073065

(51) Int. Cl. G06F 17/60

(52) U.S. Cl. 705/51; 705/52

(57) ABSTRACT

According to a request from a broadcast facility or a user terminal, a billing server encrypts broadcast data for a broadcast facility or a user terminal that will receive the broadcast data, distributes encryption keys for decrypting the encrypted broadcast data, stores the viewing commencement time of the program and the user information, periodically carries out updating of the encryption key, and carries out confirmation of reception of the encryption key, and at the same time, in the case that a request from the user terminal to terminate viewing of a program that is being viewed is received, or in the case that the confirmation of the reception of the encryption key is not obtained during the update, determines that the reception should terminate, and carries out billing processing such that the billing assessed depending on the time that the user of the user terminal was viewing the program.

### BACKGROUND OF THE INVENTION

1. Field of the Invention

The present invention relates to an Internet broadcast billing system for a fee-based broadcast carried out using the Internet.

2. Description of the Related Art

Conventionally, the method of scrambling all channels and billing each channel as a unit and the method of billing users for a broadcast unit such as one movie seen using a video on demand format are known as systems of billing for fee-based broadcasting. In these billing methods, which are generally used for satellite broadcasts and cable broadcasts, a dedicated receiving device requiring troublesome remodeling by the user is installed at the receiving end, and this device carries out the requests for reception, unscrambling, confirmation of the reception condition, and the like.

In addition, a method in which income depends completely on advertising while the broadcast itself is free, and a method in which the image and voice data for one entire broadcast are sent to the user terminal in exchange for a fee and the user then plays this at a desired time are known in this field as billing systems for the Internet.

However, the following problems occur in the above-described conventional billing systems.

First, there is the problem that an entire channel or data for one broadcast is a very inexact billing unit for assessing billing, and the convenience for the user is low.

Second, in the conventional billing system for the Internet, a broadcast whose content has little commercial value cannot be broadcast if income depends completely on advertising income, and in addition, the real time characteristic is lost if the playing of the broadcast data only begins once the download has ended.

### SUMMARY OF THE INVENTION

In consideration of the above-described problems, it is an object of the present invention to provide an Internet broadcast billing system that allows billing depending on the amount of time that the user has viewed a fee-based broadcast, without loss of the real time characteristic.

In a billing system for fee-based video and audio broadcasts and the like on the Internet, the present invention allows billing according to the amount of the user's viewing time, and controls the viewing time at the server side without the installation of a separate device at the user terminal side.

In FIG. 1, the billing server 3 distributes encryption keys for encrypting the broadcast data to the broadcast facility 2, and the broadcast data encrypted by this encryption key is sent over the Internet. The user who will view a broadcast sends information about the program to be viewed and user information from the user terminal 1 to the billing server 3. At the billing server 3, the encryption key is encrypted using a format that is readable only by the user, and sent to the user terminal. Meanwhile, the viewing starting time and the user information are recorded. At the user terminal, the broadcast data is decrypted using the encryption key, and the viewing commences.

Billing server 3 periodically updates the key for the user terminal 1 and the broadcast facility 2, and receives an acknowledgement (Ack). In the case that the billing server 3 receives a request to cancel the viewing from the user terminal, or in the case that a confirmation of the reception of the key during the update is not obtained from the user terminal, providing a new key to the user at the next periodic key update time is stopped. Depending on the amount of time that the user viewed the broadcast, the financial institution host 4 requests a usage fee from the user via the account settlement network.

In this manner, billing can be carried out depending on the amount of time that the user has viewed the broadcast.

Specifically, in order to attain the above objects, in an Internet broadcast billing system having a billing server that bills the user of a user terminal that has viewed the program of broadcast data sent to the user terminal via the Internet from a broadcast facility, in a first aspect of the invention a billing server distributes encryption keys for encrypting the broadcast data or decrypting the encrypted broadcast data to the broadcast facility and the user terminal that will receive the broadcast data depending on requests from the broadcast facility or the user terminal; stores the viewing starting time of the program and user information; periodically updates the encryption key; and carries out confirmation of the reception of the encryption keys. At the same time, in the case that a request to stop the viewing of the program is received from the user terminal, or in the case that a confirmation of reception during the update of the encryption key is not obtained, the billing server cancels the distribution of a new encryption key during the next periodic key update, and at this point in time, determines that the reception has been terminated, and carries out billing processing so as to bill the amount of time that the user of the user terminal viewed the program.

In addition, in the Internet broadcast billing system according to the first aspect, in a second aspect of the invention the billing server and the broadcast facility are formed in the same system.

In addition, in the Internet broadcast billing system having a billing server that bills the user of a user terminal that views a program of broadcast data transmitted to the user terminal side via the Internet from the broadcast facility, in a third aspect of the invention, the billing server receives the encrypted broadcast data output from the broadcast facility, encrypts broadcast data that has not been encrypted by using an encryption key, distributes the encryption keys to the user terminal for decrypting the encrypted broadcast data depending on the request from the user terminal, stores the viewing commencement time of the program and the user information, carries out updating of the encryption key periodically, carries out confirmation of the reception of the encryption keys, and at the same time, in the case that a request for terminating the viewing of the program being viewed is received from the user terminal, and in the case that confirmation of reception of the encryption keys during updating is not obtained, cancels the distribution of the new encryption key during the next periodic encryption key update, at this point in time, determines that the reception has been terminated, and carries out billing processing so that the user of the user terminal is billed depending on the amount of viewing time.

### BRIEF DESCRIPTION OF THE DRAWINGS

FIG. 1 is a block diagram showing the structure of the Internet broadcast billing system according to a first embodiment of the present invention.

FIG. 2 is a flowchart showing the contents of the processing of the broadcast facility in the Internet broadcast billing system shown in FIG. 1.

FIG. 3 is a flowchart showing the content of the processing of the user terminal in the Internet broadcast billing system shown in FIG. 1.

FIG. 4 is a flowchart showing the content of the processing of the billing server in the Internet broadcast billing system shown in FIG. 1.

FIG. 5 is an explanatory diagram showing an example of the reception request screen displayed on the display device in the user terminal of the Internet broadcast billing system shown in FIG. 1.

FIG. 6 is a block diagram showing the structure of the Internet broadcast billing system according to a second embodiment of the present invention.

FIG. 7 is a block diagram showing the structure of the Internet broadcast billing system according to a third embodiment of the present invention.

### PREFERRED EMBODIMENTS OF THE PRESENT INVENTION

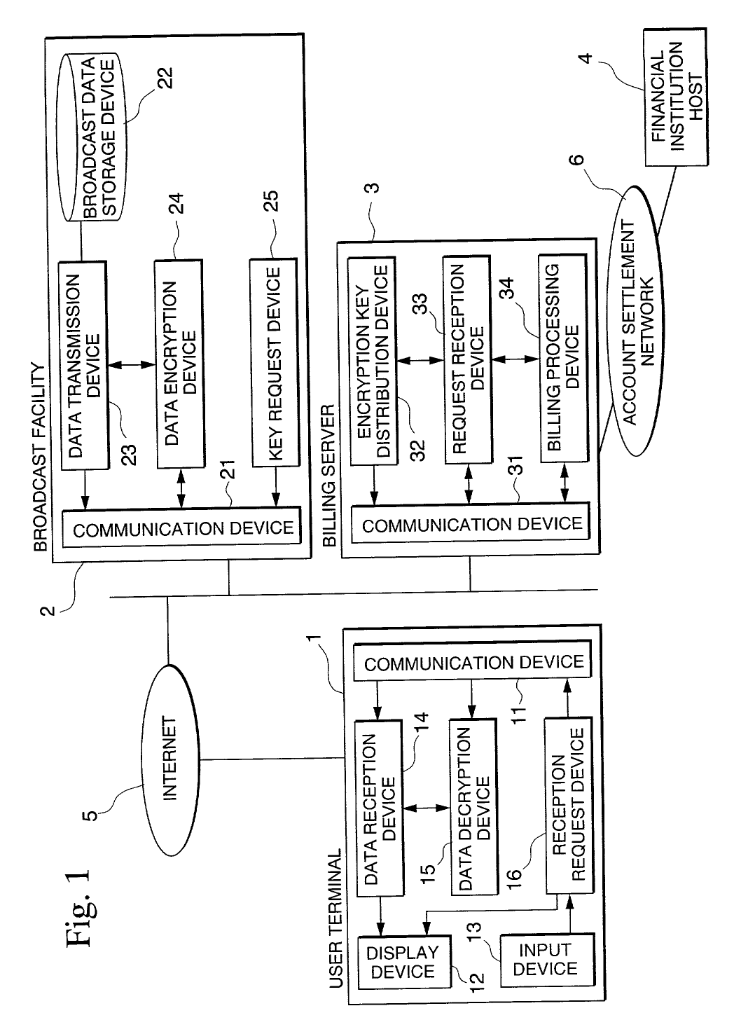

Below, embodiments of the present invention will be explained in detail referring to the drawings. FIG. 1 shows the structure of the Internet broadcast billing system according to a first embodiment of the present invention.

Referring to FIG. 1, the Internet broadcast billing system according to the first embodiment of the present invention comprises a user terminal 1, a broadcast facility 2, a billing server 3, a financial institution host 4, the Internet 5, and an accounting settlement network 6.

The user terminal 1 includes display device 12, an input device 13, a data reception device 14 that operates on the central processing unit, a data decryption device 15, and a reception request device 16. The broadcast facility 2 includes a communication device 21, a broadcast data storage device 22, a data transmission device 23, a data encryption device 24, and a key request device 25. The billing server 3 includes a communication device 31, an encryption key distribution device 32 that operates on the central processing unit, a request reception device 33, and a billing processing device 34.

In brief, these devices respectively operate as follows.

The communication device 11 of the user terminal 1 is a device that allows the data reception device 14, data encryption device 15, and reception request device 16 to carry out transmission and reception of data between the broadcast facility 2 and the billing server 3. The display device 12 outputs the broadcast data transmitted from the broadcast facility 2 to the screen and as audio. The input device 13 transmits a reception request to the reception request device 16. The data reception device 14 converts the data transmitted from the broadcast facility 2 to image and audio data, and the like, and sends these to the display device 12. The data encryption device 15 saves the data encryption key distributed by the billing server 3, and decrypts the encrypted broadcast data received from the data reception device 14. The reception request device 16 receives the input from the input device 13, and sends a reception request to the billing server 3.

The communication device 21 of the broadcast facility 2 is a device that allows the data transmission device 23, the data encryption device 24, and the key request device 25 to carry out transmission and reception of data between the user terminal 1 and the billing server 3. The broadcast data storage device 22 is a device that maintains the broadcast data. The data transmission device 23 reads the broadcast data from the broadcast data storage device 22, and transmits this to the user terminal 1. The data encryption device 24 maintains the data encryption keys distributed by the billing server 3, and encrypts the broadcast data received from the data transmission device 23. The key request device 25 requests distribution of the data encryption keys from the billing server 3.

The communication device 31 of the billing server 3 is a device that allows the encryption key distribution device 32, the request reception device 33, and the billing processor device 34 to transmit the received data between the user terminal 1, the broadcast facility 2, and the financial institution host 4. The encryption key distribution device 32 distributes the data encryption keys to the user terminal 1 and the broadcast facility 2. The request reception device 33 receives the key requests and the reception requests from the user terminal 1 and the broadcast facility 2, and carries out authentication processing. The billing processing device 34 carries out processing for requesting payment from the financial institution host 4. The financial institution host 4 carries out the collection of fees from the user based on the request from the billing server 3.

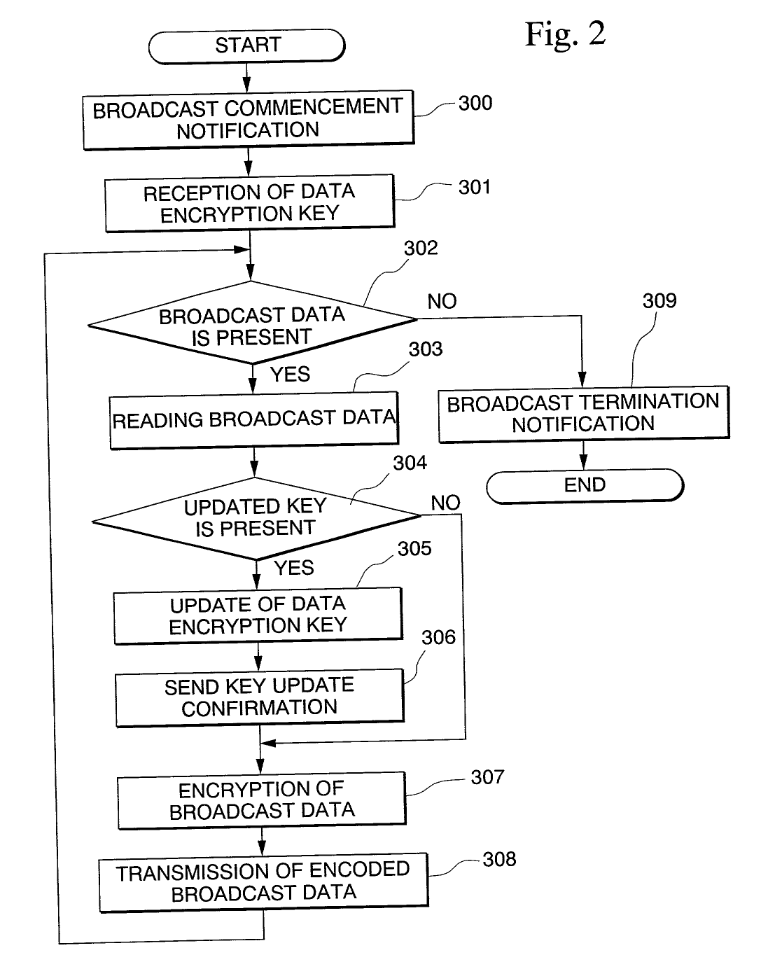

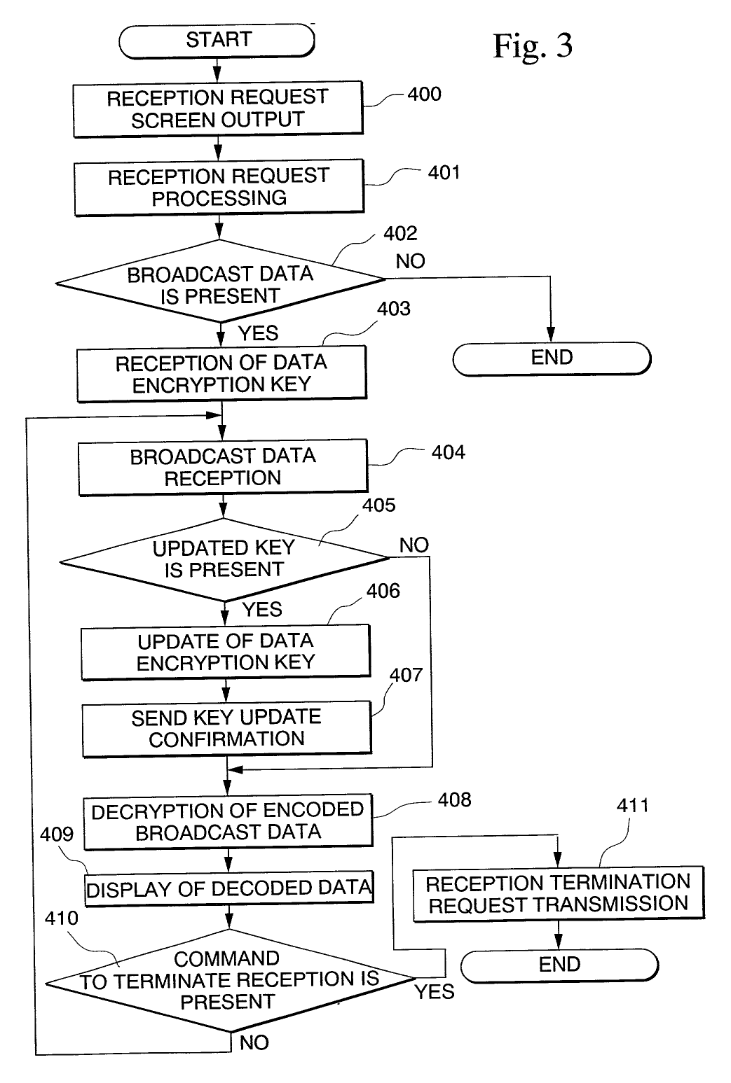

Next, the operation of the Internet broadcast billing system as a whole according to the present embodiment will be explained in detail referring to the structural drawing of the Internet broadcast billing system shown in FIG. 1 and the flowcharts in FIG. 2 through FIG. 4.

In the broadcast facility 2, first the key request device 25 transmits a broadcast commencement notification to the request reception device 33 (step 300). The broadcast commencement notification includes an ID for specifying the broadcast facility 2 and an ID for specifying a broadcast (an IP address, a port number, and the like), and uses a digital signature based on a public key encrypting format in order to prevent fraud by a third party. Subsequently, the billing server 3 transmits the data encryption key with an attached digital signature to the broadcast facility 2. The details of the processing of the billing server 3 will be described below.

The data encryption device 24 receives the encrypted data encryption key sent from the encryption key distribution device 32, and after confirming that the digital signature after decrypting is in the billing server 3, carries out preparation for data encrypting (step 301). Next, the data transmission device 23 confirms whether any data that should be broadcast is remaining in the broadcast data storage device (step 302). In the case that there is no broadcast data, the billing server 3 is notified about the end of the broadcast, and the program ends (step 309). The broadcast completion notice includes an ID for specifying the broadcast facility 2 and an ID for specifying the broadcast that has completed. In the case that broadcast data remains, the data transmission device 23 reads the broadcast data (step 303).

Next, the data encryption device 24 confirms whether a new data encryption key other than the key presently possessed has been sent from the encryption key distribution device 32 (step 304). In the case that there is an updated key, the new data encryption key is read, after decrypting the key is updated after confirming that the signature is that in the billing server 3 (step 305), and the confirmation of the reception is sent to the request reception device 33 (step 306). Subsequently, the data encryption device 24 encrypts the broadcast data using the data encryption key (step 307). During encrypting, a stream encrypting format and the like are used. In addition, in order to indicate which encryption key has carried out the encrypting, an ID for identifying the key that was used in the encrypting is attached to the broadcast data.

The data transmission means 23 streams the encrypted broadcast data over the Internet 5 according to communication protocols such as IP multicasting (step 308). Step 302 and thereafter are repeated until there is no more data to be broadcast.

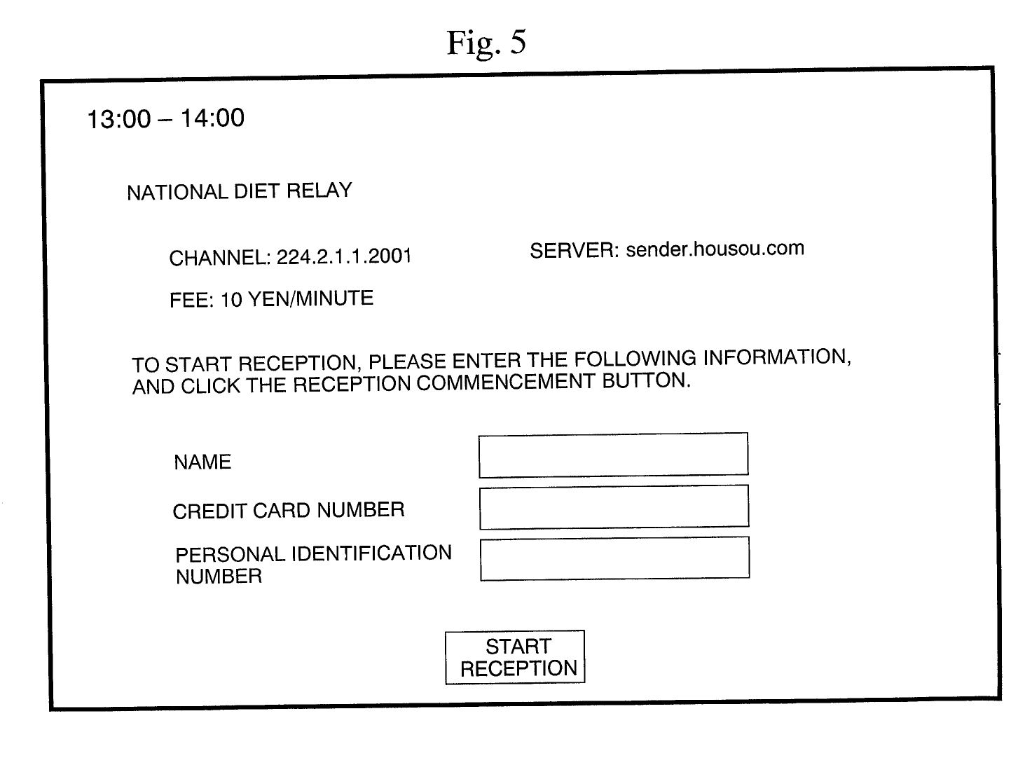

Next, in the user terminal 1, first the reception request device 16 outputs the reception request screen to the screen (step 400). The reception request screen is displayed using a Web browser and the like, and comprises, for example, information that allows the user to select a broadcast to be viewed, an input field for individual information necessary for the payment of fees, and a button for receiving a request to commence viewing. An example of a reception request screen is shown in FIG. 5. Next, the input for the commencement of the viewing from the user is received, and the ID of the selected broadcast and the reception request that includes individual information are sent to the request reception means 32 (step 401).

At this time, as a security measure, measures such as attaching a digital signature based on a private key of the user are carried out after encrypting the information and adding the present date and time to the data. The processing of the billing server 3 that receives the reception request will be described below. The data decryption device 15 possesses a data encryption key sent from the encryption key distribution device 32 (step 402). In the case that an error message is sent from the encryption key distribution device 32 instead of the data encryption key, the program terminates. The received data encryption key is decrypted, and after confirming that the digital signature is in the billing server 3, preparation for data encrypting is carried out (step 403).

Next, the data reception device 14 begins the reception of the broadcast data from the data reception device 23 (step 404). Because there is the possibility that due to timing the data key for encrypting the broadcast data has not been received before the data decryption device 15 decrypts the broadcast data, at this point in time, the data decryption device 15 confirms whether the new data encryption key has been sent from the encryption key distribution means 32 (step 405). In the case that there is an updated key, the new data encryption key is read, and after confirming that the name is in the billing server 3 after decrypting, the key is saved (step 406), and the confirmation of the reception is sent to the request reception device 33 (step 407).

Subsequently, based on the identification ID of the data key that has been attached to the broadcast data, the data decryption device 15 decrypts the broadcast data encrypted using the corresponding data encryption key corresponding to this ID (step 408). The data reception device 14 displays the decrypted broadcast data on the display device 12 (step 409). After commencement of the reception of the broadcast data, the reception request device 16 changes the screen display to the screen that receives the reception termination from the reception request screen shown in FIG. 5, and receives the reception termination request from the user (step 410). When a reception termination request has been received, after the reception request device 16 transmits the reception termination request to the request reception device 33, the program terminates (step 411). Step 404 and after repeats until receiving a command to terminate reception from the user.

In the billing server 3, first the request reception device 33 carries out packet reception from the user terminal 1 and the broadcast facility 2 and event generation waiting of the key update timing interval and the like (step 500). When an event is generated, subsequent processing is carried out depending on the content of the event (step 501).

First, in the case that the event is a key request from the key request device 25, the ID of the included broadcast facility 2 and the digital signature are confirmed, and then it is determined whether or not data encryption key distribution should be carried out (step 502). In the case that the distribution of the data encryption keys is carried out, after the encryption key distribution means 32 generates a data encryption key and encrypts the data encryption key using the public key of the broadcast facility 2 so that the data encryption key is readable only by the broadcast facility 2, the digital signature is attached depending on the private key of the billing server 3, and sent to the data encryption device 24 (step 503).

The data encryption key includes a unique key ID for identification. The transmitted data encryption key, the ID for broadcasting, and the broadcast time are grouped into a unit and stored (step 504). In addition, a timer for key updating is started, and set so that for each billing unit, for example, one minute, a key update event is generated (step 505). The processing returns to the event-waiting state after this setting.

In contrast, when the event is a reception request from the reception request means 16, after carrying out decryption processing, the included individual information and the broadcast ID that the user desires are read, and then it is determined whether or not data encryption key distribution should be carried out (step 506). In this determination, a device is used that confirms whether the user is a registered user who has registered in advance, and confirms the user's ability to pay by referring to the financial institution host 4. In the case that distribution of the data encryption key is carried out, after the data encryption key corresponding to a broadcast ID is read based on the broadcast ID that the user desires and the data encryption key is encrypted using the public key of the user so that the data encryption key is only readable by the user, then the digital signature is attached using the private key of the billing server, and this is sent to the data decryption device 15 (step 507).

A unique key ID for identification is included in the data encryption key. The transmitted personal information of the user, the broadcast ID, the transmitted address information of the user terminal 1, and the transmission time are grouped into a unit and stored (step 508). After storage, the processing returns to the event-waiting state.

In the case that the event is a timeout of the key update timer, a new data encryption key is generated, and this is sent to the data encrypting means 24 of the recorded broadcast facility 2 and the data decryption device 15 of all recorded user terminals 1 (step 509). At this time, like the initial data encryption key, encrypting and assigning of a digital signature are carried out. In addition, the timer for the key update confirmation is started, and after an amount of time substantially sorter than the billing unit, for example, 10 seconds, the timer is set so as to generate to key update confirmation (step 510). After this setting, the program returns to the event-waiting state.

In addition, in the case that the event is the key update confirmation from the data encryption device 24 or the data decryption device 15, whether or not this is from a valid system is authenticated (step 511), and the broadcast ID, the transmitted address information of the host, and the reception time are grouped into a unit and stored (step 512). After storage, the program returns to the event-waiting state.

In the case that the event is a timeout of the update confirmation waiting timer, if there is a user terminal 1 that has not transmitted an update confirmation, this user is treated as having terminated, and the personal information and present time are recorded. In addition, in the case that the event is the reception termination request from the reception request device 16, the user's individual information and the present time are recorded. In addition, in the case that the event is a broadcast termination request from the broadcast facility 2, the same information is recorded for all users (step 513). The billing processing device 34 calculates the reception fee based on the amount of time that the user was receiving the broadcast, and entrusts the financial institution host 4 with the collection of the fee from the user (step 514). Subsequently, the program returns to the event-waiting state to wait for the next event.

According to the Internet broadcast billing system of the first embodiment of the present invention, whether a user is viewing a program for billing purposes can be confirmed by the confirmation of the reception of the data encryption key during the updating, and thereby the user can be billed for viewing time. This billing system has a billing configuration that is particularly suited for sports broadcasts and live music broadcasts on the Internet, the minimum fee for the use time can be lowered, and in addition, in the case that the content is not of interest, subsequent viewing can be stopped at any time, and thus the psychological hurdle of the user in deciding to make a purchase can be lowered, and there is the effect that the user's desire to purchase will increase.

Moreover, the broadcast data in the present embodiment may be numerical or text data such as share price information, in addition to image data and voice data. In addition, instead of storing the data in advance in a device, the broadcast data can use data input from a camera or microphone that is broadcast in real time. The broadcast configuration is not limited to unidirectional broadcasting, but can be configured for bi-directional communication, such as for a conference.

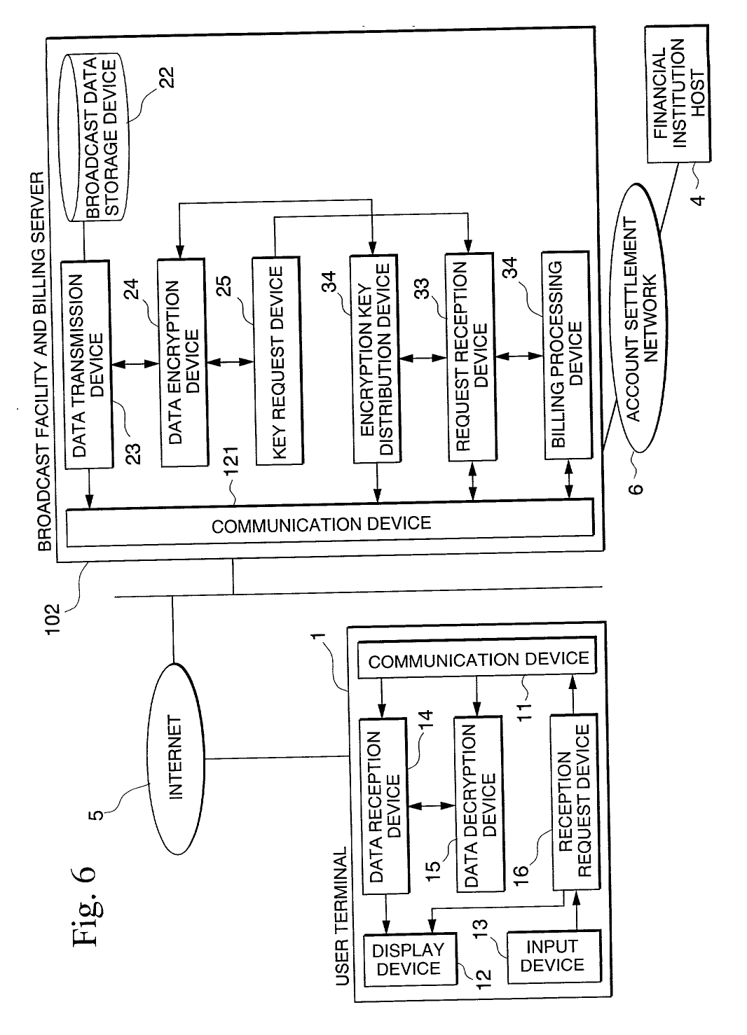

Next, the structure of an Internet broadcast billing system according to a second embodiment of the present invention is shown in FIG. 6. The Internet broadcast billing system according to this embodiment differs structurally from the Internet broadcast billing system according to the first embodiment on the point that the broadcast facility 2 and the billing server 3 are formed on the same system. Because the remaining structure is identical, the identical elements have identical reference numerals, and their explanation has been omitted.

Referring to FIG. 6, the present embodiment comprises a user terminal 1, broadcast facility and billing server 102, a financial institution host 4, the Internet 5, and an account settlement network 6. The structure of the user terminal 1 is identical to that in the embodiment shown in FIG. 1. The broadcast facility and billing server 102 comprises a communication device 121, a broadcast data storage device 22, a data transmission device 23, a data encryption device 24, a key request device 25, an encryption key distribution device 32, a request reception device 33, and a billing processing device 34. The operation of the present embodiment as a whole is identical, except for the point that the data encryption device 24 and the key request device 25 can exchange data directly with the encryption key distribution device 32 and request reception device 33, without passing through a communication network, and the point that therefore in this data exchange, encrypting and the signature are not necessary.

According to the Internet broadcast billing system of the second embodiment of the present invention, in the case that the broadcast business implementing the embodiment and the business carrying out the billing are the same business, the installation is simplified because the broadcast facility 2 and the billing server 3 are implemented on the same system.

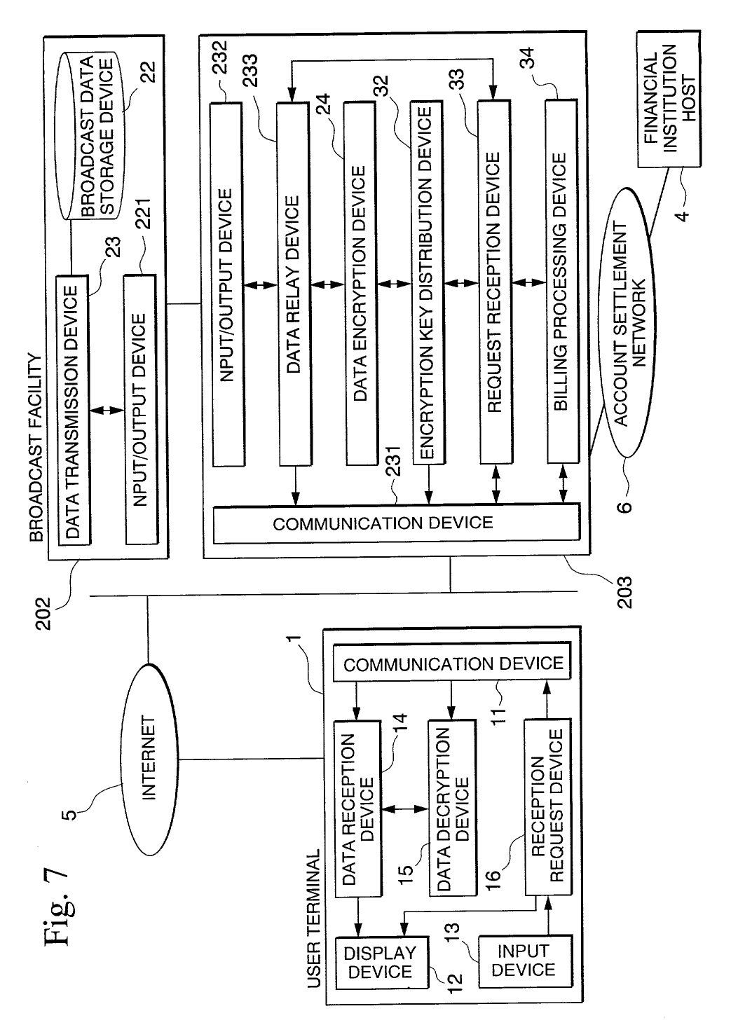

Next, the structure of an Internet broadcast billing system according to a third embodiment of the present invention is shown in FIG. 7. The Internet broadcast billing system according to this embodiment differs structurally from the Internet broadcast billing system according to the first embodiment on the point that plain data is sent before encrypting from the broadcast facility and encrypting processing and billing processing are carried out in the relay server. Because the remaining structure is identical, the identical elements have identical reference numerals, and their explanation has been omitted.

Referring to FIG. 7, the Internet broadcast billing system according to this embodiment comprises a user terminal 1, a broadcast facility 202, a relay server 203, a financial institution host 4, the Internet 5, and an account settlement network 6. The structure of the user terminal 1 is identical to that of the embodiment shown in FIG. 1. The broadcast facility 202 comprises an input/output device 221, a data transmission device 23, and a broadcast data storage device 22. The relay server 203 comprises a communication device 231, an input/output device 232, a data relay device 233, a data encryption device 24, an encryption key distribution device 32, a request reception device 33, and a billing processing device 34.

Next, referring to FIG. 7, the entire operation of the Internet broadcast billing system according to the present embodiment will be explained in detail. The operation of the user terminal 1 is identical to that in the flowchart in FIG. 2. In the broadcast facility 202, the data transmission device 23 reads the broadcast data from the broadcast data storage device 22 at an arbitrary timing, and transmits as is the broadcast data to the relay server via the input/output device 221, without carrying out processing for encrypting and the like. At the relay server, first the data relay device 233 waits for reception of the broadcast data.

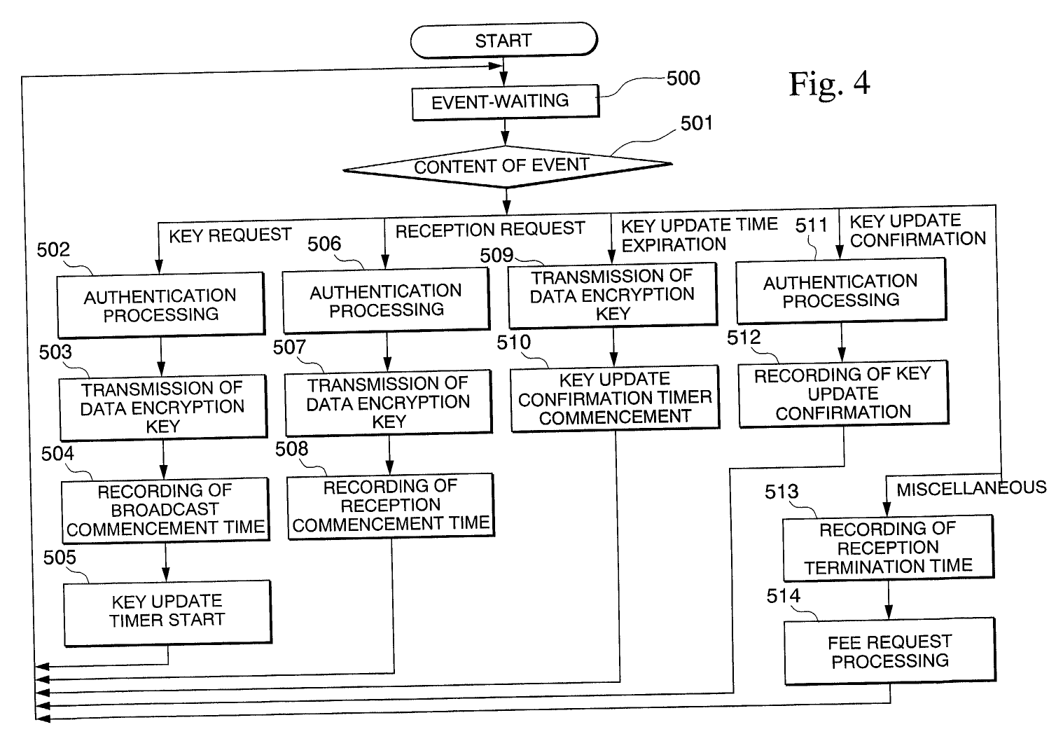

After the reception has occurred, the processing of the data relay device 233 and the data encryption device 24 carry out the same processing as that shown in the flowchart in FIG. 2. However, the following points are different: the point that instead of reading the broadcast data from a broadcast data storage device 22, the broadcast data is received from the data transmission device 23; the point that data can be exchanged directly between the encryption key distribution device 32 and the request reception device 33; and the point that therefore in data exchange, encrypting and the signature are not necessary. The operation of the encryption key distribution device 32, the request reception device 33, and the billing processing device 34 are identical to that in the flowchart shown in FIG. 4.

According to the Internet broadcast billing system according to the third embodiment of the present invention, plain data is sent before encrypting from the broadcast device and the encrypting processing and billing processing are carried out in the relay server, and therefore existing equipment can be used in the broadcast facility.

In addition, as another embodiment, before carrying out billing, a fixed amount of time can be viewed for free and during this time the user can indicate selecting to continue the viewing for a fee or ending the viewing. Thereby, the effect is produced that the user can confirm beforehand the content of the broadcast, and the user can be offered material for determining whether or not to pay a fee. In this case, at the point in time that the reception request device 16 shows the reception request screen shown in FIG. 5, a free reception request is sent to the request reception device 32. Unlike the original reception request, individual information is not included in the free reception request. After the passage of a fixed amount of time, the key management server 3 that has received the free reception request cuts off the transmission processing of the data encryption key for the terminal that has made the free reception request.

In addition, as another embodiment for the case in which free viewing is possible before billing, it is possible to implement automatic switching without the user indicating from the screen the express desire to view for a fee, and whether the present reception is for free or for a fee can be displayed on the screen. In this case, the billing server separately maintains the individual information of the user necessary for billing, and the request for payment is made to the financial institution host 4 using this individual information.

In addition, as another embodiment for the case in which free viewing is possible before billing, while viewing for free, advertising can be displayed on the screen separately from the broadcast data. Thereby, for the period during which viewing is for free, a business that supplements the cost of the portion of the broadcast data viewed for free can be compensated by the advertising fee by receiving an advertising fee from third parties.

The present invention bills according to the viewing time of the user, and in embodiments like this one, the explanation of the embodiment has been made assuming that fees will be collected from the viewer using the user terminal. However, parties other than the viewer, for example, the broadcast business, can be billed. In this case, for a service that provides a device that carries out fee-based broadcasting to the broadcast business, a business configuration that collects fees from the broadcast business depending on use time can be realized.

In addition, in the case that the broadcast is bidirectional instead of unidirectional, there is no distinction between transmitting and receiving, and the billing of all persons who receive the data encryption key can be carried out. Thereby, there is the effect that a business becomes possible that obtains earnings by providing a place for carrying out a conference for people who wish to carry out a conference and the like on the Internet.

Furthermore, for the broadcast time or the viewed time, billing of third parties such as advertisers can be carried out. Thereby, the effect is attained that an accurate amount of time during which the broadcast data was viewed can be obtained, and an appropriate advertising fee can be obtained from the advertiser.

As an embodiment of the present invention for the case in which the object of billing is not the viewer, the correspondence between the user who viewed the broadcast and the individual information of the billing destination therefor are recorded in the billing server 3, and based on the user's actual viewing, the billing processing device 34 requests the billing for the individual information that is the corresponding billing destination from the financial institution host 4.

According to the present invention explained above, in an Internet broadcast billing system having a billing server that bills the user of a user terminal that views the program of broadcast data transmitted from a broadcast facility to a user terminal via the Internet, this billing server encrypts the broadcast data for the broadcast facility or for a user terminal that receives the broadcast data depending on the request from the broadcast facility or the user terminal, distributes an encryption key for decrypting the encrypted broadcast data, records the time that viewing a program began and the user information, carries out periodical updating of the encryption key, carries out confirmation of the reception of the encryption keys, and at the same time, in the case that a request to terminate the viewing of a broadcast being viewed is received from the user terminal, and in the case that a confirmation of the reception of this encryption key is not obtained during the update time, the distribution of a new encryption key during the next periodic encryption key update is stopped, and at this point in time, it is determined that the reception has completed, and billing processing is carried out so that the user of the user terminal is billed for the viewing time, and thus the real time character is not lost, and the user is billed for the fee-based broadcast depending on the viewing time.

What is claimed is:

1. An Internet broadcast billing system having a billing server that bills the user of a user terminal that has viewed the program of broadcast data sent to the user terminal via the Internet from a broadcast facility, wherein a billing server is constructed to carry out the steps of:
distributing encryption keys for encrypting the broadcast data or decrypting the encrypted broadcast data to the broadcast facility and the user terminal that will receive the broadcast data depending on requests from the broadcast facility or the user terminal;
a storing the viewing starting time of the program and user information;
periodically updating the encryption keys;
carrying out confirmation of the reception of the encryption keys;
canceling the distribution of a new encryption key during the next periodic key update in the case that a request to stop the viewing of the program is received from the user terminal or in the case that a confirmation of reception during the update of the encryption key is not obtained and determining that the reception has been terminated; and
carrying out billing processing so as to bill the amount of time that the user of the user terminal viewed the program.

2. An Internet broadcast billing system according to claim 1 wherein the billing server and the broadcast facility are formed in the same system.

3. An Internet broadcast billing system having a billing server that bills the user of a user terminal that views a program of broadcast data transmitted to the user terminal side via the Internet from the broadcast facility, wherein the billing server is constructed to carry out the steps of:
receiving the unencrypted broadcast data output from the broadcast facility;
encrypting broadcast data that has not been encrypted by using an encryption key;
distributing the encryption key to the user terminal for decrypting the encrypted broadcast data depending on the request from the user terminal;
storing the viewing commencement time of the program and the user information;
carrying out updating of the encryption key periodically;
carrying out confirmation of the reception of the encryption key;
canceling distribution of the new encryption keys during the next periodic encryption key update in the case that a request for terminating the viewing of the program being viewed is received from the user terminal and in the case that confirmation of reception of the encryption key during updating is not obtained and determining that the reception has been terminated; and
carrying out billing processing so that the user of the user terminal is billed depending on the amount of viewing time.
